(19) United States
(12) Patent Application Publication
(10) Pub. No.: US 2025/0311043 A1
(43) Pub. Date: Oct. 2, 2025

(54) Mobile Relay Base Station Operation for New Radio

(71) Applicant: Apple Inc., CUPERTINO, CA (US)

(72) Inventors: Rohit R MATOLIA, Bangalore (IN); Alosious Pradeep PRABHAKAR, Singapore (SG); ChunLei LIN, NT (HK); Sudeep MANITHARA VAMANAN, Uttenreuth (DE); Vijay VENKATARAMAN, San Jose, CA (US)

(21) Appl. No.: 18/863,240

(22) PCT Filed: May 3, 2023
(86) PCT No.: PCT/US2023/020776

§ 371 Date: Nov. 5, 2024

(30) Foreign Application Priority Data
May 6, 2022 (IN) 202241026341

(51) Int. Cl. H04W 76/20; H04W 12/06; H04W 60/04; H04W 84/04

(52) U.S. Cl. CPC H04W 76/20; H04W 12/06; H04W 60/04; H04W 84/042

(57) ABSTRACT

A user equipment (UE) configured to transmit a registration request to a base station of a network, the registration request including access node (AN) parameters comprising an indication of whether the UE intends to operate as a mobile base station relay and receive a response to the registration request from the network. An access and mobility management function (AMF) configured to receive a message from a radio access network (RAN), the message comprising an indication of whether a user equipment (UE) intends to operate as a mobile base station relay and transmit a response to the message to the RAN.

### BACKGROUND

A mobile base station relay may serve as a relay between a user equipment (UE) and a network. In some examples, the mobile base station relay may be mounted on a vehicle (e.g., a vehicle mounted relay (VMR)) and serve one or more UEs located inside or outside of the vehicle. It has been identified that there is a need for enhancements for the fifth generation (5G) system to support the operation of mobile base station relays using new radio (NR) for wireless access.

### SUMMARY

Some exemplary embodiments are related to a processor of a user equipment (UE) configured to perform operations. The operations include transmitting a registration request to a base station of a network, the registration request including access node (AN) parameters comprising an indication of whether the UE intends to operate as a mobile base station relay and receiving a response to the registration request from the network.

Other exemplary embodiments are related to an access and mobility management function (AMF) configured to perform operations. The operations include receiving a message from a radio access network (RAN), the message comprising an indication of whether a user equipment (UE) intends to operate as a mobile base station relay and transmitting a response to the message to the RAN.

### BRIEF DESCRIPTION OF THE DRAWINGS

FIG. 1 shows an exemplary network arrangement according to various exemplary embodiments.

FIG. 2 shows an exemplary mobile base station relay according to various exemplary embodiments.

FIG. 3 shows an exemplary user equipment (UE) according to various exemplary embodiments

FIG. 4 shows an exemplary base station according to various exemplary embodiments.

FIG. 5 shows exemplary network architecture according to various exemplary embodiments.

FIG. 6 shows a signaling diagram for a registration procedure according to various exemplary embodiments.

FIG. 7 shows a signaling diagram for when vehicle mounted relay (VMR)/mobile base station relay (MBSR) operation is not allowed according to various exemplary embodiments

FIG. 8 shows a signaling diagram for limiting mobility of the mobile base station relay according to various exemplary embodiments.

FIG. 9 shows a signaling diagram for configuring mobile base station relay operation when a change in roaming state occurs according to various exemplary embodiments.

### DETAILED DESCRIPTION

The exemplary embodiments may be further understood with reference to the following description and the related appended drawings, wherein like elements are provided with the same reference numerals. The exemplary embodiments relate to mobile base station relay operation in a fifth generation (5G) new radio (NR) network.

The exemplary embodiments are described with regard to a user equipment (UE) configured to operate as a mobile base station relay. The term “mobile base station relay” may be used to refer to a mobile network node acting as a relay between a UE and the network. In some deployment scenarios, the mobile base station relay may be mounted on a moving vehicle and serve one or more UEs located inside or outside of the vehicle. This type of mobile base station relay may be referred to as a “vehicle mounted relay (VMR).” Throughout this description, the terms “mobile base station relay,” “VMR” and “UE” may be used interchangeably to refer to the same device.

A mobile base station relay may attempt to attach to a network and operate as a relay depending on its location and movement. However, the mobile base station relay may lack the authorization policy and/or configuration needed to attach to the network and serve as a relay. Accordingly, to support mobile base station relay deployment, there is a need for a dynamic provisioning mechanism configured to provide the mobile base station relay with the authorization policy and/or configuration needed to attach to the network and serve as a relay.

The mobile base station relay may have a home public land mobile network (HPLMN) and roam from its HPLMN to a visited PLMN (VPLMN). As will be described in more detail below, when using an integrated access and backhaul (IAB) architecture, the mobile base station relay may consist of a gNB-donor unit (DU) and an IAB-UE. In a roaming scenario, the IAB-UE may behave as a UE and thus, be able to access a VPLMN using UE procedures. It has been identified that there is a need for techniques configured to support the gNB-DU component of the mobile base station relay.

The mobile base station relay may serve one or more UEs that move together with the mobile base station relay. For example, the UEs may deployed inside a vehicle with a VMR. When the mobile base station relay is no longer able to serve as a relay (e.g., moved outside of a service area, ran out of service time, etc.), the one or more UEs may then be served by a base station or another mobile base station relay. In addition, when a mobile base station relay moves to a new location, UEs outside of the vehicle may benefit from utilizing the mobile base station relay. Therefore, in some scenarios, it may be beneficial for a UE to move from a serving mobile base station relay to a base station or a second different mobile base station relay. In other scenarios, it may be beneficial for the UE to move from a serving base station to a mobile base station relay. Accordingly, there is a need for techniques configured to support UE mobility between a base station relay and another node (e.g., another mobile base station relay, a base station, etc.).

The exemplary embodiments introduce various techniques configured to support the deployment of mobile base station relays. The exemplary techniques relate to various different aspects of mobile base station relay operation including, but not limited to, the various issues discussed in the examples provided above. For instance, some of the exemplary embodiments relate to a registration procedure for a UE to operate as a mobile base station relay. Other exemplary embodiments include techniques for implementing an authorization policy for mobile base station relay operation. Further exemplary embodiments include techniques for implementing a mobile base station relay operation policy related to PLMNs. In addition, the exemplary embodiments introduce techniques for efficient UE mobility between a mobile base station relay and another node (e.g., base station, mobile base station relay, etc.). Each of the exemplary embodiments described herein may be used independently from one another, in conjunction with currently implemented mobile base station relay mechanisms, future implementations of mobile base station relay mechanisms or independently from other mobile base station relay mechanisms.

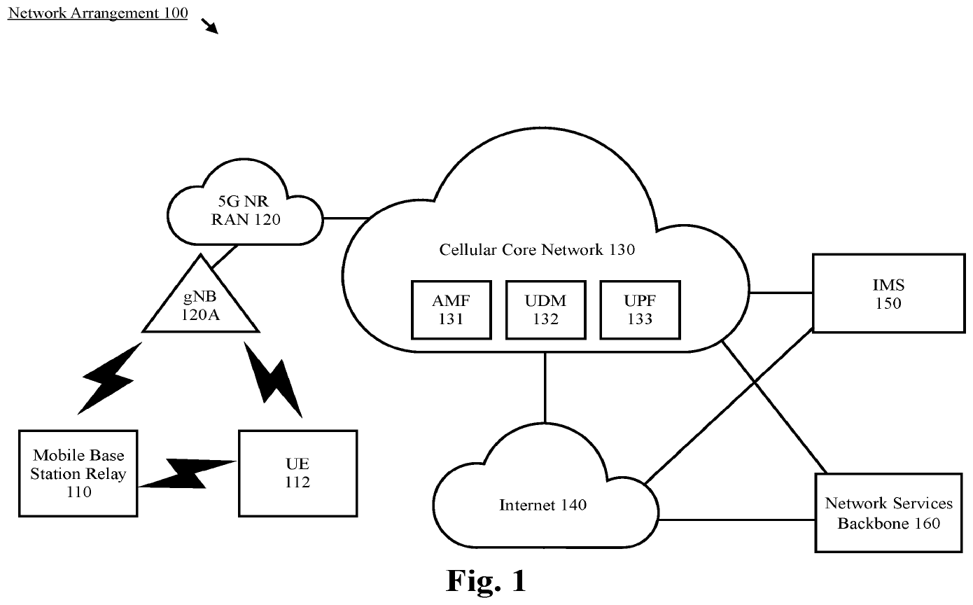

FIG. 1 shows an exemplary network arrangement 100 according to various exemplary embodiments. The exemplary network arrangement 100 includes a mobile base station relay 110 and a UE 112. The mobile base station relay may be an electronic component mounted to a vehicle (e.g., a VMR) or any other type of electronic component configured to communicate with a network. Those skilled in the art will understand that the UE 112 may be any type of electronic component that is configured to communicate via a network, e.g., mobile phones, tablet computers, desktop computers, smartphones, phablets, embedded devices, wearables, Internet of Things (IoT) devices, etc. In some example, the mobile base station relay 110 and the UE 112 may be the same type of device. In other examples where the mobile base station relay 110 is a VMR, the UE 112 may be deployed inside or outside of the vehicle. It should also be understood that an actual network arrangement may include any number of mobile base station relays and any number of UEs being used by any number of users. Thus, the example of a mobile base station relay 110 and a single UE 112 is merely provided for illustrative purposes.

The mobile base station relay 110 and the UE 112 may be configured to communicate with one or more networks. In the example of the network arrangement 100, the network with which the mobile base station relay 110 and the UE 112 may wirelessly communicate is a 5G NR radio access network (RAN) 120. However, it should be understood that the UE 110 may also communicate with other types of networks (e.g., 5G cloud RAN, a next generate RAN (NG-RAN), a legacy cellular network, a wireless local area network (WLAN), etc.) the mobile base station relay 110 and the UE 112 may also communicate with one another and/or other networks over a wired connection. Therefore, the mobile base station relay 110 and the UE 112 may each have a 5G NR chipset to communicate with the NR RAN 120 and, optionally, any other appropriate type of chipset to communicate with other types of networks.

In various examples provided below, the mobile base station relay 110 may serve as a relay between the UE 112 and the 5G NR RAN 120/core network 130. Thus, in some examples, the UE 112 may transmit uplink data to the 5G NR RAN 120 by first transmitting one or more signals to the mobile base station relay 110. The mobile base station relay 110 may then communicate with the 5G NR RAN 120 over the air (e.g., via the qNB 120A) on behalf of the UE 112. Similarly, downlink data intended for the UE 111 may be transmitted by the gNB 120A over the air to the mobile base station relay 110 which then relays the downlink data over the air to the UE 112. However, the UE 112 may also be served by the gNB 120A.

The 5G NR RAN 120 may be a portion of a cellular network that may be deployed by a network carrier (e.g., Verizon, AT&T, Sprint, T-Mobile, etc.). The 5G NR RAN 120 may include cells and base stations that are configured to send and receive traffic from UEs (and relays) that are equipped with the appropriate cellular chip set. In this example, the 5G NR RAN 120 includes the gNB 120A. However, reference to a gNB is merely provided for illustrative purposes, the exemplary embodiments may be utilized with any appropriate type of access node may be (e.g., Node Bs, eNodeBs, HeNBs, eNBs, gNBs, gNodeBs, macrocells, microcells, small cells, femtocells, etc.).

Those skilled in the art will understand that any association procedure may be performed by the mobile base station relay 110 and/or the UE 112 to connect to the 5G NR RAN 120. For example, as discussed above, the 5G NR RAN 120 may be associated with a particular network carrier where the mobile base station relay 110 and/or the user thereof has a contract and credential information (e.g., stored on a SIM card, etc.). Upon detecting the presence of the 5G NR RAN 120, the mobile base station relay 110 may transmit the corresponding credential information to associate with the 5G NR RAN 120. More specifically, the mobile base station relay may associate with a specific base station, e.g., the gNB 120A.

The network arrangement 100 includes a cellular core network 130. The cellular core network 130 may be considered to be an interconnected set of components that manages the operation and traffic of the cellular network. In this example, the components may include an access and mobility management function (AMF) 131, a unified data management (UDM) 132 and a user plane function (UPF) 133. The AMF 131 is generally responsible for connection and mobility management in the 5G NR RAN 120. Those skilled in the art will understand that the AMF 131 is a control plane function and may perform operations related to registration management and connection management. For example, the AMF 131 may perform operation related to registration management between the mobile base station relay 110 and the network. The UDM 132 may handle subscription related information to support various network services. The UPF 133 may perform operations related to packet data unit (PDU) session management. For example, the UPF 133 may facilitate a connection between UEs and an edge data network.

Each of the AMF 131, the UDM 132 and the UPF 133 may be equipped with one or more communication interfaces to communicate with other networks and/or network components (e.g., network functions, RANs, UEs, etc.). Those skilled in the art will understand that in an actual network arrangement the AMF 131, the UDM 132 and the UPF 133 may reside in various physical and/or virtual locations relative to the network arrangement 100. These locations may include the 5G NR RAN 120, the core network 130, as separate components outside of these locations, etc. In addition, reference to a single AMF 131, UDM 132 and UPF 133 is merely provided for illustrative purposes, an actual network arrangement may include any appropriate number of AMFs and UDMS.

The cellular core network 130 also manages the traffic that flows between the cellular network and the Internet 140. The IMS 150 may be generally described as an architecture for delivering multimedia services to the UE 112 using the IP protocol. The IMS 150 may communicate with the cellular core network 130 and the Internet 140 to provide the multimedia services to the UE 112. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 112 in communication with the various networks.

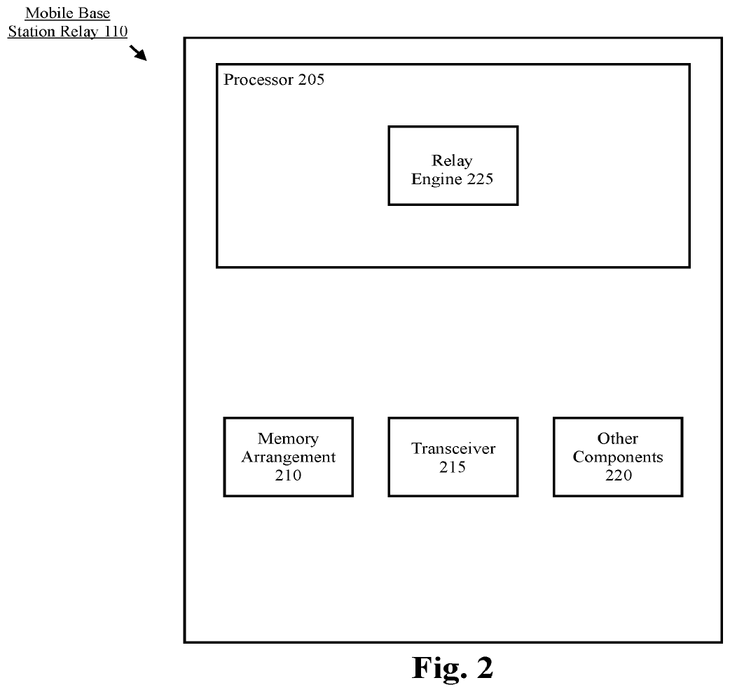

FIG. 2 shows an exemplary mobile base station relay 110 according to various exemplary embodiments. The mobile base station relay 110 will be described with regard to the network arrangement 100 of FIG. 1. The mobile base station relay 110 may include a processor 205, a memory arrangement 210, a transceiver 215 and other components 220. The other components 220 may, for example, an audio input/output (I/O) device, a power supply, a data acquisition device, ports to electrically connect the mobile base station relay 110 to other electronic devices, etc.

The processor 205 may be configured to execute a plurality of engines of the mobile base station relay 110. For example, the engines may include a relay engine 225. The relay engine 225 may perform various operations related to operating as a relay between one or more UEs and a 5G NR network.

The above referenced relay engine 225 being an application (e.g., a program) executed by the processor 205 is merely provided for illustrative purposes. The functionality associated with the relay engine 225 may also be represented as a separate incorporated component of the mobile base station relay 110 or may be a modular component coupled to the mobile base station relay 110, e.g., an integrated circuit with or without firmware. For example, the integrated circuit may include input circuitry to receive signals and processing circuitry to process the signals and other information. The engines may also be embodied as one application or separate applications. In addition, in some devices, the functionality described for the processor 205 is split among two or more processors such as a baseband processor and an applications processor. The exemplary embodiments may be implemented in any of these or other configurations of a mobile base station relay.

The memory arrangement 210 may be a hardware component configured to store data related to operations performed by the mobile base station relay 110. The transceiver 215 may be a hardware component configured to establish a connection with the UE 112, the 5G NR-RAN 120, etc. Accordingly, the transceiver 215 may operate on a variety of different frequencies or channels (e.g., set of consecutive frequencies).

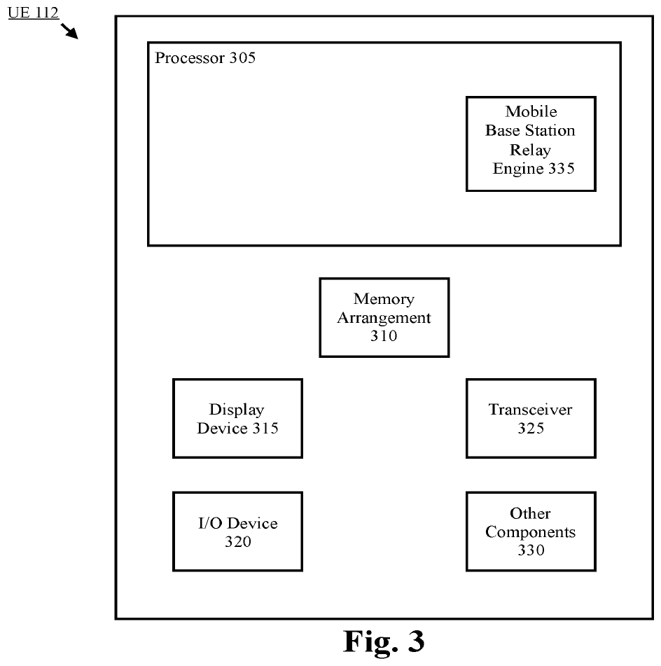

FIG. 3 shows an exemplary UE 112 according to various exemplary embodiments. The UE 112 will be described with regard to the network arrangement 100 of FIG. 1. The UE 112 may include a processor 305, a memory arrangement 310, a display device 315, an input/output (I/O) device 320, a transceiver 325 and other components 330. The other components 330 may, for example, an audio input device, an audio output device, a power supply, a data acquisition device, ports to electrically connect the UE 112 to other electronic devices, etc.

The processor 305 may be configured to execute a plurality of engines of the UE 112. For example, the engines may include a mobile base station relay engine 335. The mobile base station relay engine 335 may perform various operations related to establishing and maintaining a connection to a 5G NR network via the base station relay 110. The above referenced mobile base station relay engine 335 being an application (e.g., a program) executed by the processor 305 is merely provided for illustrative purposes. The functionality associated with the mobile base station relay engine 335 may also be represented as a separate incorporated component of the UE 112 or may be a modular component coupled to the UE 112, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 305 is split among two or more processors such as a baseband processor and an applications processor. The exemplary embodiments may be implemented in any of these or other configurations of a UE.

The memory arrangement 310 may be a hardware component configured to store data related to operations performed by the UE 112. The display device 315 may be a hardware component configured to show data to a user while the I/O device 320 may be a hardware component that enables the user to enter inputs. The display device 315 and the I/O device 320 may be separate components or integrated together such as a touchscreen. The transceiver 325 may be a hardware component configured to establish a connection with the 5G NR-RAN 120, an LTE-RAN (not pictured), a legacy RAN (not pictured), a WLAN (not pictured), etc. Accordingly, the transceiver 325 may operate on a variety of different frequencies or channels (e.g., set of consecutive frequencies).

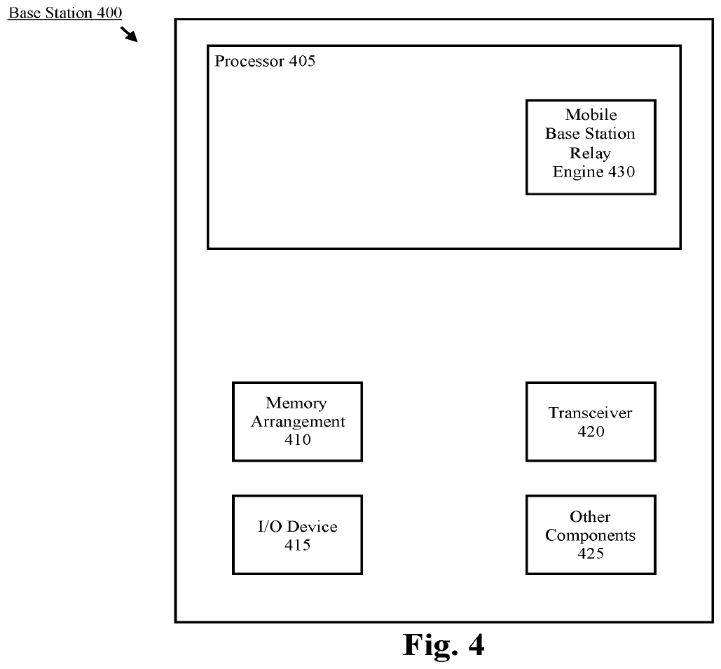

FIG. 4 shows an exemplary base station 400 according to various exemplary embodiments. The base station 400 may represent the gNB 120A or any other appropriate type of network access node.

The base station 400 may include a processor 405, a memory arrangement 410, an input/output (I/O) device 415, a transceiver 420 and other components 425. The other components 425 may include, for example, antenna panels, a data acquisition device, ports to electrically connect the base station 400 to other electronic devices and/or power sources, etc.

The processor 405 may be configured to execute a plurality of engines of the base station 400. For example, the engines may include a mobile base station relay engine 430. The mobile base station relay engine 430 may perform various operations related to registration of a mobile base station relay and communicating with one or more UEs via the mobile base station relay.

The above noted mobile base station relay engine 430 being an application (e.g., a program) executed by the processor 405 is only exemplary. The functionality associated with the mobile base station relay engine 430 may also be represented as a separate incorporated component of the base station 400 or may be a modular component coupled to the base station 400, e.g., an integrated circuit with or without firmware. For example, the integrated circuit may include input circuitry to receive signals and processing circuitry to process the signals and other information. In addition, in some base stations, the functionality described for the processor 405 is split among a plurality of processors (e.g., a baseband processor, an applications processor, etc.). The exemplary embodiments may be implemented in any of these or other configurations of a base station.

The memory arrangement 410 may be a hardware component configured to store data related to operations performed by the base station 400. The I/O device 415 may be a hardware component or ports that enable a user to interact with the base station 400. The transceiver 420 may be a hardware component configured to exchange data with the mobile base station relay 110, the UE 112 and any other device in the network arrangement 100. The transceiver 420 may operate on a variety of different frequencies or channels (e.g., set of consecutive frequencies).

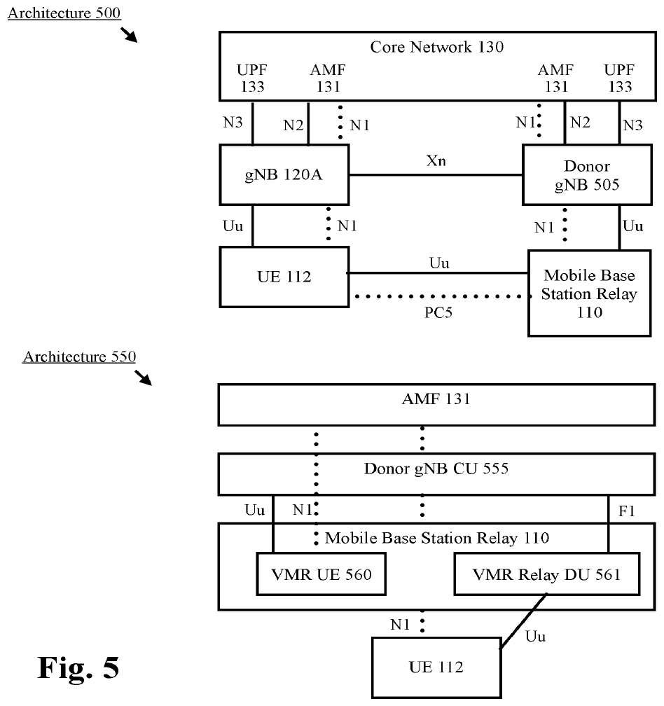

FIG. 5 shows exemplary network architecture according to various exemplary embodiments. The following description will provide a general overview of the various components of the exemplary architectures 500 and 550. The specific operations performed by the components with respect to the exemplary embodiments will be described in greater detail after the description of the architectures 500 and 550.

Those skilled in the art will understand that the components of the exemplary architectures 500 and 550 may reside in various physical and/or virtual locations relative to the network arrangement 100 of FIG. 1. These locations may include, within the access network (e.g., 5G NR RAN 120), within the core network 130, as separate components outside of the locations described with respect to FIG. 1, etc.

In FIG. 5, the various components are shown as being connected via interfaces labeled Nx (e.g., N1, N2, N3), Uu, PC5,Xn and F1. Those skilled in the art will understand that each of these interfaces are defined in the 3GPP Specifications. The exemplary architectures 500 and 550 use these interfaces in the manner in which they are defined in the 3GPP Specifications and may be modified in accordance with the exemplary embodiments described herein. Furthermore, it should be understood that these interfaces are not required to be direct wired or wireless connections, e.g., the interfaces may communicate via intervening hardware and/or software components. Furthermore, it should be understood that these interfaces are not required to be direct wired or wireless connections, e.g., the interfaces may communicate via intervening hardware and/or software components. To provide an example, the UE 112 may exchange signals over the air with the gNB 120A. However, in the architecture 500 the UE 112 is shown as having a connection to the AMF 131. This interface is not a direct communication link between the UE 110 and the AMF 131, instead, it is a connection that is facilitated by intervening hardware and software components. Thus, throughout this description the terms “connection” and “interface” may be used interchangeably to describe the different interfaces between the various components in the exemplary architectures 500 and 550.

The exemplary architectures 500 and 550 are described with regard to integrated access and backhaul (IAB). Those skilled in the art will understand that IAB refers to a concept where the same access technology is used by an end device to access a base station and the base station itself to access the wireless backhaul. In some examples, the mobile base station relay 110 may be considered an IAB node.

The exemplary architectures are also described with regard to a logical architecture of a gNB which comprises a central unit (CU) and a distributed unit (DU). The term “gNB-CU” may refer to a logical node that is connected to the core network and one or more gNB-DUs. The term “gNB-DU” may refer to a logical node that is connected to a gNB-CU. However, reference to the terms “gNB-CU” and “gNB-DU” is merely provided for illustrative purposes. Different entities may refer to similar concepts by a different name.

The architecture 500 includes the core network 130 (e.g., the 5G core (5GC)), the gNB 120A, a donor gNB 505, the UE 112 and the mobile base station relay 110. The UE 112 may connect to the gNB 120A via the Uu interface and the AMF 131 via the N1 interface. The gNB 120A may connect to the UPF 133 via the N3 interface and the AMF 131 via the N2 interface.

The mobile base station relay 110 may connect to the donor gNB 505 via the Uu interface and the AMF 131 via the N1 interface. The donor gNB 505 may connect to the UPF 133 via the N3 interface and the AMF 131 via the N2 interface. In addition, the donor gNB 505 may connect to the gNB 120A via the Xn interface. Those skilled in the art will understand that term “donor” may refer to a node that is configured to serve a relay node. Thus, in the architecture 500, the donor gNB 505 may serve the mobile base station relay 110.

The UE 112 may connect to the mobile base station relay 110 via the Uu interface and/or the PC5 interface. Thus, the UE 112 may connect to the core network 130 via the gNB 120A and/or the mobile base station relay 110.

The architecture 550 includes the AMF 131, a donor gNB CU 555 of the gNB 120A and the mobile base station relay 110 comprising a VMR UE 560 and a VMR relay DU 561. The AMF 131 may connect to the UE 112 via a N1 interface and the VMR UE 560 via the N1 interface. The donor gNB CU 555 may control the VMR DU 561 via the F1 interface. The VMR UE 560 may connect to the donor gNB CU via the Uu interface. The UE 112 may connect to the VMR DU 561 via the Uu interface.

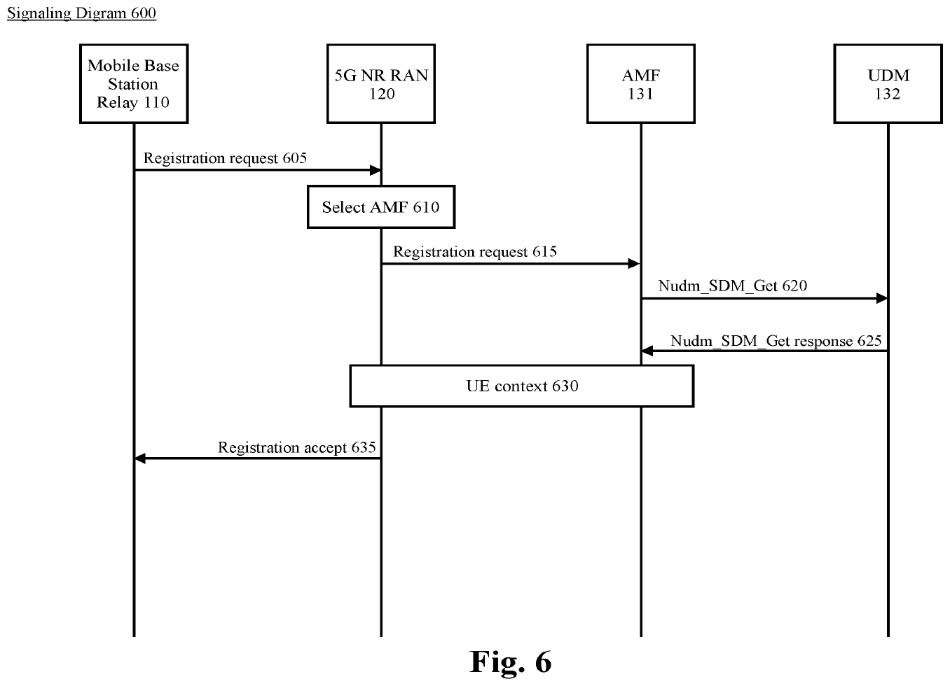

According to one aspect, the exemplary embodiments relate to a UE registering with a network to operate as a mobile base station relay (e.g., VMR, etc.). FIG. 6 shows a signaling diagram 600 for a registration procedure according to various exemplary embodiments. The signaling diagram 600 includes the mobile base station relay 110, the 5G NR RAN 120, the AMF 131 and the UDM 132.

In 605, the mobile base station relay 110 transmits a registration request to the 5G NR RAN 120. For example, a UE may transmit a registration request to the gNB 120A indicating that the UE would like to operate as mobile base station relay (MBSR), VMR, etc.

The registration request may include access node (AN) parameters. In some embodiments, the AN parameters may comprise an IAB indication indicating that the mobile base station relay 110 intends to operate as an IAB node. In addition, the AN parameters may include a VMR/MBSR indication indicating that the mobile base station relay 110 is a VMR/MBSR node attempting to attach to the 5G system. Thus, a UE may inform the network the UE is a stationary IAB node, a normal UE or mobile base station relay (VMR, MBSR, etc.). Without the VMR/MBSR indication, the network may not know whether the requesting node (e.g., mobile base station relay 110) is capable of mobile base station relay operation.

In 610, the 5G NR RAN 120 selects an AMF. The 5G NR RAN 120 may select an AMF for the mobile base station relay 110 that supports mobile base station relay operation. In this example, the 5G NR RAN 120 selects the AMF 131.

To provide an example within the context of architecture 550, the mobile base station relay 110 may send the VMR/MBSR indication to the donor gNB CU 555 of the gNB 120A when a radio resource control (RRC) connection is established. The donor gNB CU 555 may select an AMF that supports mobile IAB and/or MBSR. The donor GNB CU may include the VMR/MBSR indication in an N2 initial UE 110 message so that the AMF may perform MBSR authorization.

In 615, the 5G NR RAN 120 transmit the registration request to the AMF 131. For example, this request may be transmitted over the N2 interface and include an establishment cause. In addition, the AMF 131 may provide the IAB indication and the VMR/MBSR indication provided by the mobile base station relay 110 in the AN parameters.

In 620, the AMF 131 transmits a Nudm_SDM_Get service operation to the UDM 132. Those skilled in the art will understand that the Nudm_SDM_Get service operation may be used by a network function to retrieve subscriber data from the UDM. The Nudm_SDM_Get service operation may include a network function ID and subscription data types (e.g., VMR, MBSR, etc.).

In 625, the UDM 132 transmits a Nudm_SDM_Get response to the AMF 131. In this example, the UDM 132 checks the subscription information for the mobile base station relay 110 and provides a VMR/MBSR operation allowed indication to the AMF 131 as part of the access and mobile subscription data provided in the response message. In addition, the UDM 132 may provide an IAB operation allowed indication.

In 630, the AMF 131 and the 5G NR RAN 120 establish a UE context for the mobile base station relay 110. In one example, the AMF 131 and the 5G NR RAN 120 may setup the appropriate UE context for the mobile base station 110 to operate as a VMR/MBSR. In another example, the AMF 131 and the 5G NR RAN 120 may modify the UE context for the mobile base station relay 110 if this functionality was not previously authorized. In 635, the 5G NR RAN 120 sends a registration accept message to the mobile base station relay 110. In this example, the registration accept message may indicate that VMR/MBSR operation is allowed and IAB operation is allowed.

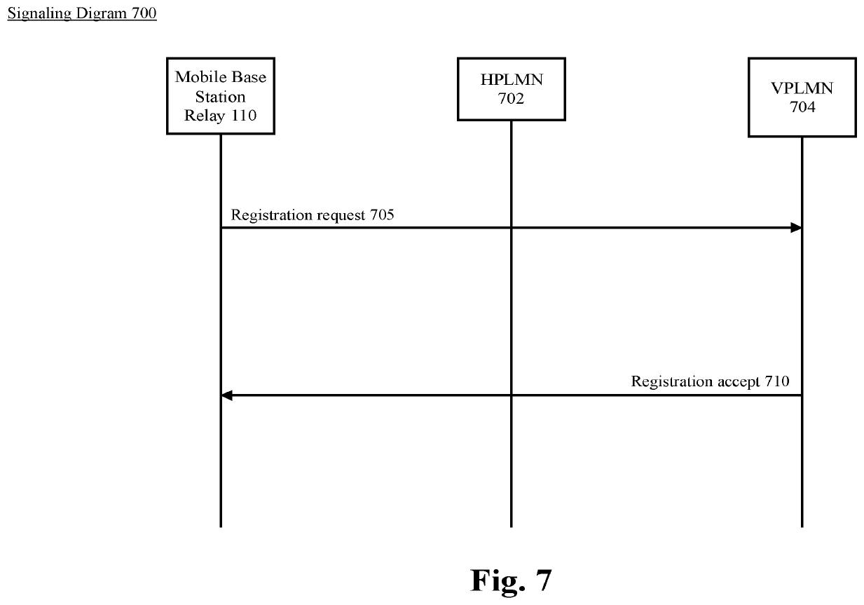

In another aspect, the exemplary embodiments include techniques for implementing a mobile base station relay operation policy related to PLMNs. FIG. 7 shows a signaling diagram 700 for when VMR/MBSR operation is not allowed according to various exemplary embodiments. The signaling diagram 700 includes the mobile base station relay 110, an HPLMN 702 and a VPLMN 704.

Initially, assume a scenario in which the mobile base station relay 110 is connected to the HPLMN 702 and moving towards the VPLMN 704. However, while this example is described with regard to PLMNs, those skilled in the art will understand that a similar signaling exchange may be used when the mobile base station relay is moving between registration areas (RAS).

In 705, the mobile base station relay 110 transmits a registration request to the VPLMN 704. The registration request may indicate that the request is for initial or mobility registration. In addition, the request may include a VMR/MBSR indication indicating that the mobile base station relay 110 would like to attach to the VPLMN 704 and operate as a mobile base station relay.

In 710, the VPLMN 704 may transmit a registration accept message to the mobile base station relay 110. However, in this example, the mobile base station relay is not authorized to operate in the VPLMN 704. Therefore, the registration accept message may include an indication that VMR/MBSR operation is not allowed. Thus, the reject message may be configured to let a UE know whether the UE can operate as a mobile base station relay, a normal UE or both.

In response to the registration accept message, the mobile base station relay 110 may operate as a normal UE within the VPLMN 704 but is not allowed to operate as a mobile base station relay. For example, the mobile base station relay 110 may connect as a UE to the VPLMN 704 for operation, administration and maintenance (OAM) or emergency services.

In some embodiments, a backoff timer may be triggered in response to the VMR/MBSR operation is not allowed indication. When the backoff timer expires, the mobile base station relay 110 may transmit a registration request to the VPLMN 704 requesting to operate as a VMR/MBSR. In other embodiments, a location based condition may be used to trigger a subsequent registration request from the mobile base station relay 110 to the VPLMN 704. For example, the location based condition may comprise, but is not limited to, one or more of the following factors, a change in serving cell within the VPLMN 704, a change in signal strength or quality from a serving cell, a change in location or a predicted change of location. When the condition is identified, the mobile base station relay 110 may transmit a registration request to the VPLMN 704 requesting to operate as a VMR/MBSR.

As indicated above, there may be scenarios where the mobile base station relay 110 is not authorized to operate as a VMR/MBSR in a PLMN but may connect to the PLMN as a UE for other services (e.g., OAM, emergency, etc.). According to some aspects, the exemplary embodiments introduce techniques where the mobile base station relay 110 may store information about whether the mobile base station relay 110 is permitted to operate as a VMR/MBSR.

In some embodiments, the mobile base station relay 110 may store information about PLMNs and where VMR/MBSR operation is allowed. This information may be considered by the mobile base station relay 110 when selecting a PLMN during a PLMN search. For example, since the mobile base station relay 110 may prefer to attach to a PLMN where VMR/MBSR operation is allowed, the mobile base station relay 110 may consider this information when selecting between multiple PLMNs. Without this information, the mobile base station relay 110 may be able to register with a PLMN as a UE but may not know whether VMR/MBSR operation is permitted on this PLMN.

In other embodiments, the mobile base station relay 110 may store information about PLMNs and where VMR/MBSR operation is not allowed. This information may be considered by the mobile base station relay 110 when selecting a PLMN during a PLMN search. For example, since the mobile base station relay 110 may prefer to attach to a PLMN where VMR/MBSR operation is allowed, the mobile base station relay 110 may consider this information when selecting between multiple PLMNs. Without this information, the mobile base station relay 110 may attempt to register on a PLMN that does not support VMR/MBSR operation which may cause a delay in VMR/MBSR operation initiation or resumption.

The above examples may be used to implement an authorization policy for acting as a 5G VMR/MBSR node (e.g., IAB node with mobility functionality). The authorization policy may include providing an indication as to whether a node (e.g., the mobile base station relay 110) attempting to register with a network may perform IAB, VMR and/or MBSR operations. The authorization policy may also include PLMNs in which the node is authorized to perform VMR/MBSR operations. This may be configurable by steering of roaming (SoR) using an operator PLMN (OPLMN) list for VMR/MBSR operations and normal UE operation.

In some embodiments, the mobile base station relay 110 may have operational requirements for OAM, layer 2 (L2) relay or PC5 discovery, mobility assistance and control amongst relays. It has been identified that there is a need for two type of policies for these operations, UE route selection policy (URSP) and proximity services (ProSe) policies. For URSP, the mobile base station relay 110 may follow procedure from 3GPP TS 23.50 and policy framework from 3GPP TS 23.505 for UE URSEP policies if the 5GC support VMR/MBSR operation of this UE (e.g., the mobile base station relay 110). For PC5 policy, the mobile base station relay 110 may follow ProSe policy from 3GPP TS 23.304 for ProSe related policies. Thus, for VMR/MBSR (e.g., IAB node) mobility, PDU operation policies for a 5GC connection may include session parameters (e.g., PDU session type, data network name (DNN), session and service continuity (SSC) modes, single network slice selection assistance information (S-NSSAI), access type preference) to be used for the connectivity between the mobile base station relay 110 and 5GC for relaying traffic to and from UEs.

The exemplary embodiments also introduce techniques for implementing a next hop policy. Under conventional circumstances, when roaming, the VPLMN, RAN and/or OAM may not have next hop parameters defined for the roaming mobile base station relay 110. However, it would be beneficial for the HPLMN to provide operational policies for HPLMN and VPLMN operations.

In some embodiments, the HPLMN may configure the mobile base station relay 110 with radio parameters for IAB, VMR and/or MBR operation. The radio parameters may include frequencies on which IAB, VMR and/or MBSR operation is allowed with a geographical area where the IAB/VMR/MBSR node if allowed to operate. This may include the tracking area (TA) or registration area (RA) in which this operation is valid. In addition, the HPLMN may provide quality of service (QoS) mapping entries for services that may be supported and provided to served UEs by the mobile base station relay 110.

The exemplary embodiments introduce a VMR/MBSR policy container that may be provided to the mobile base station 110 to inform the mobile base station 110 of the relevant policies for VMR/MBSR operation. The VMR/MBSR policy container may include the authorization policy information, operation policy information, radio parameters for IAB/VMR/MBSR operation, QoS mapping information and any other relevant policies. The authorization policy information may include information for acting as a 5G VMR/MBSR node (e.g., an IAB node with mobility functionality) such as an indication for whether the current node can perform IAB/VMR/MBSR operations, PLMNs in which the IAB is authorized to perform VMR/MBSR operations in mobility and configurable by SoR during roaming (OPLMN list for UE VMR/MBSR operations or UE normal operations). The operation policy information may include information for 5GC connection such as information for CMR/MBSR mobility, the PDU session parameters to be used for the connectivity between VMR/MBSR and 5GC for relaying UEs traffic. The radio parameters for IAB/VMR/MBSR operation may include radio parameters with a geographical area where the IAB/VMR/MBSR node is allowed to operate and may also include tracking area/registration are in which this operation shall be valid. The QoS mapping information may include QS mapping entries for services that may be supported and provided to served UEs.

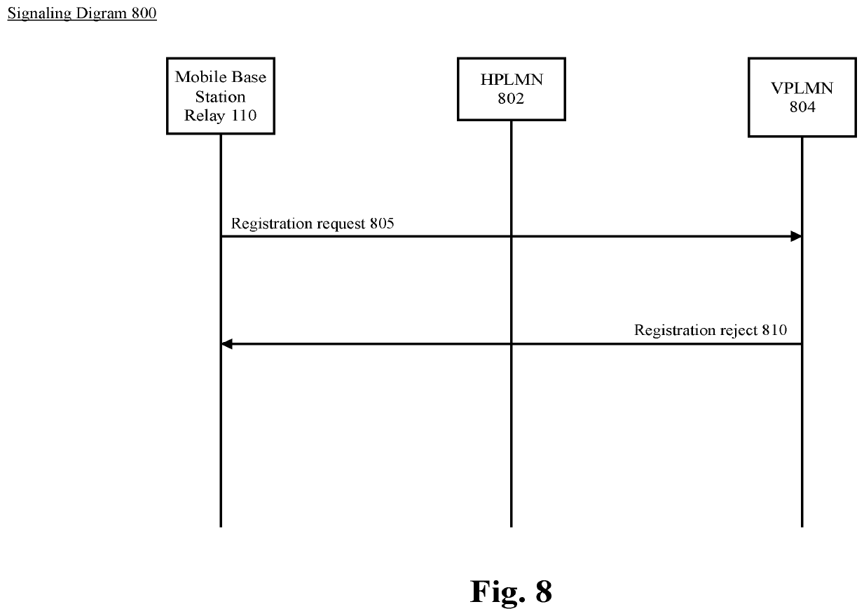

The exemplary embodiments also introduce techniques for limiting mobility of the mobile base station relay 110 to VPLMNs. FIG. 8 shows a signaling diagram 800 for limiting mobility of the mobile base station relay 110 according to various exemplary embodiments.

The signaling diagram 800 includes the mobile base station relay 110, HPLMN 802 and a VPLMN 804. Initially, assume a scenario in which the mobile base station relay is connected to the HPLMN 802 and moves to the VPLMN 804.

In 805, the mobile base station relay 110 may transmit a registration request to the VPLMN 804. For example, the mobile base station relay 110 may perform a mobility update after moving from the HPLMN 802 to the VPLMN 804.

In 810, the VPLMN 804 may transmit a registration reject message to the mobile base station relay 110. Alternatively, the VPLMN 804 may transmit a deregistration request to the mobile base station 110.

In one example, when a target gNB belongs to a VPLMN and/or TA/RA which does not support VMR/MBSR operations or does not allow VMR/MBSR operation, the AMF of the VPLMN 804 may reject the registration request or send deregistration request with reject cause #11, #13 and/or #15 to the mobile base station relay 110. Subsequently, the mobile base station relay 110 may search for other cells and/or PLMNs.

In another example, the mobile base station relay 110 may release the f1 interface and stay connected as a normal UE. This may be defined in the VMR/MBSR policy on whether in certain TA/RA/PLMNs or geographical areas, the VMR/MBSR UE may operate as normal UE when coming back to an area where mobile base station relay operations are allowed.

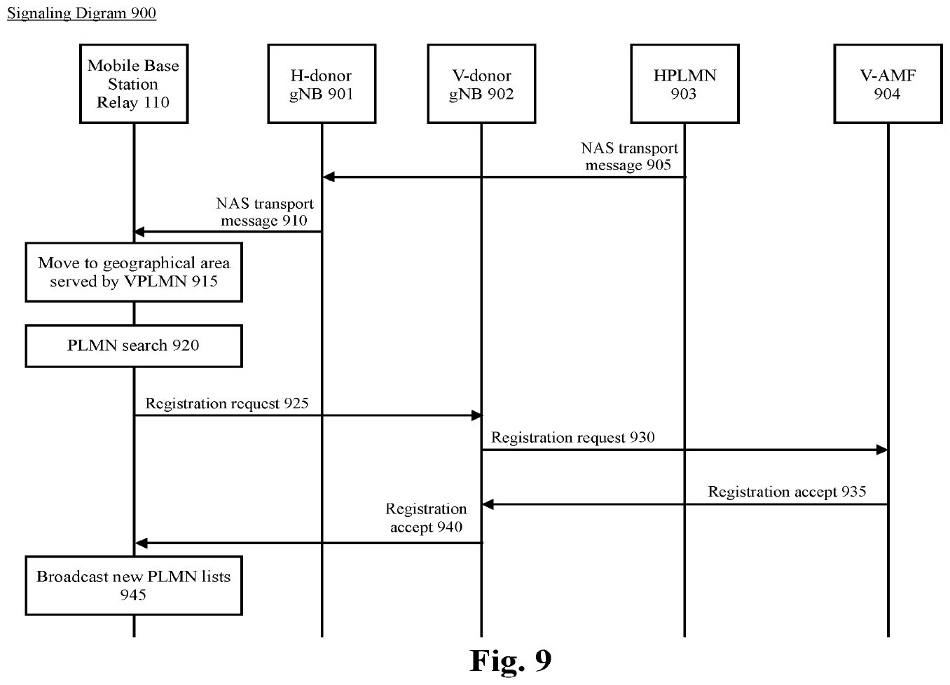

The exemplary embodiments also introduce techniques for mobile base station relay configuration when a roaming state changes. FIG. 9 shows a signaling diagram 900 for configuring mobile base station relay operation when a change in roaming state occurs according to various exemplary embodiments.

The signaling diagram 900 includes the mobile base station relay 110, a donor gNB of the HPLMN (H-donor gNB) 901, a donor gNB of the VPLMN (V-donor gNB) 902, a HPLMN 903 and an AMF of the VPLMN (V-AMF) 904. Initially, assume a scenario in which the mobile base station relay 110 is connected to the HPLMN 903.

In 905, the HPLMN 903 transmit a downlink non-access stratum (NAS) transport message to the H-donor gNB 901. This message may include SoR information comprising an information element (IE) indicating that VMR/MBSR operation allowed in roaming is to be added. In 910, the H-donor gNB may transport the downlink NAS transport message including the SoR information and the IE indicating that VMR/MBSR operation allowed in roaming is to be added.

In 915, the mobile base station relay 110 moves to a geographical area served by the VPLMN. In 920, the mobile base station relay 110 performs a PLMN search for a VPLMN based on the SoR information received from the H-donor gNB 901.

In 925, the mobile base station relay 110 transmits a registration request to the V-donor gNB 902. In 930, the V-donor qNB 902 transmits the registration request to the V-AMF 904. In 935, the V-AMF 904 may transmit a registration accept message to the V-donor gNB 902. The registration accept message may include a “VMR/MBSR PLMN list/TA” IE introduced herein. This IE may allow the mobile base station relay to be shared among multiple carriers.

In 940, the V-donor gNB 902 transmits the registration accept message to the mobile base station relay 110. In 945, the mobile base station relay 110 broadcasts new PLMN lists to serve UEs.

### EXAMPLES

In a first example, a method performed by a user equipment (UE), comprising transmitting a registration request to a base station of a network, the registration request including access node (AN) parameters comprising an indication of whether the UE intends to operate as a mobile base station relay and receiving a response to the registration request from the network.

In a second example, the method of the first example, wherein the indication is provided to a donor-centralized unit (CU) of the base station when a radio resource control (RRC) connection is established by the UE.

In a third example, the method of the first example, wherein the response is a registration accept message comprising an indication that mobile base station relay operation is not allowed.

In a fourth example, the method of the third example, further comprising initiating a backoff timer in response to the indication included in the registration accept message and transmitting a second registration request to the base station of the network comprising the indication of whether the UE intends to operate as a mobile base station relay.

In a fifth example, the method of the third example, further comprising identifying, after the registration accept message is received, a location based condition and transmitting a second registration request to the base station of the network comprising the indication of whether the UE intends to operate as a mobile base station relay, wherein transmitting the second registration request is triggered based on identifying the location based condition.

In a sixth example, the method of the first example, further comprising storing information associated with one or more public land mobile networks (PLMNs), the information comprising an indication for each of the one or more PLMNs indicating whether mobile base station relay operation is allowed or not allowed.

In a seventh example, the method of the first example, further comprising receiving radio parameters for mobile base station relay operation, including frequency of operation and a geographical area where mobile base station relay operation is allowed.

In an eighth example, the method of the first example, further comprising receiving radio parameters for mobile base station relay operation, at least one of a tracking area (TA) or registration area (RA) where mobile base station relay operation is allowed.

In a ninth example, the method of the first example, further comprising receiving quality of service (QoS) mapping entries for services the UE may support when operating as the mobile base station relay and serving other UEs.

In a tenth example, the method of the first example, further comprising receiving a policy container comprising information for one or more of an authorization policy for operating as a mobile base station relay, operation policies for a fifth generation (5G) core (5GC) connection, radio parameters for mobile base station relay operation and quality of service (QoS) mapping entries for services the UE may support when operating as the mobile base station relay and serving other UEs.

In an eleventh example, the method of the first example, wherein the response to the registration request is a registration reject message comprising one or more reject causes indicating that mobile base station relay operation is not supported or allowed by the network.

In a twelfth example, the method of the first example, wherein the response to the registration request is a deregistration request message indicating that mobile base station relay operation is not supported or allowed by the network.

In a thirteenth example, the method of the first example, wherein the response to the registration request is a registration reject message or a deregistration request, the method further comprising releasing an F1 interface based on the response, wherein the UE remains connected to the network.

In a fourteenth example, the method of the first example, further comprising receiving an information element (IE) from a home public land mobile network (HPLMN), the IE comprising an indication that mobile base station relay operation is allowed in roaming scenarios.

In a fifteenth example, the method of the first example, further comprising a registration accept message comprising an information element (IE) indicating a list of public land mobile networks (PLMNs) that support mobile base station relay operation.

In a sixteenth example, one or more processors configured to perform any of the methods of the first through fifteenth examples.

In a seventeenth example, a user equipment (UE) comprising a transceiver configured to communicate with a base station and one or more processors communicatively coupled to the transceiver and configured to perform any of the methods of the first through fifteenth examples.

In an eighteenth example, a method, comprising receiving a message from a radio access network (RAN), the message comprising an indication of whether a user equipment (UE) intends to operate as a mobile base station relay and transmitting a response to the message to the RAN.

In a nineteenth example, the method of the eighteenth example, wherein the message is a N2 initial UE message.

In a twentieth example, the method of the eighteenth example, further comprising receiving a Nudm_SDM_Get response from a unified data management (UDM) indicating whether the UE is permitted to operate as a mobile base station relay.

In a twenty first example, the method of the eighteenth example, further comprising triggering a setup of a UE context or a modification of the UE context for the UE comprising an indication that the UE is authorized as a mobile base station relay.

In a twenty second example, the method of the eighteenth example, wherein the response to the message is a registration accept message comprising an information element (IE) indicating a list of public land mobile networks (PLMNs) that support mobile base station relay operation.

In a twenty third example, one or more processors configured to perform any of the methods of the eighteenth through twenty second examples.

In a twenty fourth example, an access and mobility function (AMF) of a core cellular network configured to perform any of the methods of the eighteenth through twenty second examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured to perform operations, comprising:
transmitting a registration request to a base station of a network, the registration request including access node (AN) parameters comprising an indication of whether the UE intends to operate as a mobile base station relay; and
receiving a response to the registration request from the network.

2. The processor of claim 1, wherein the indication is provided to a donor-centralized unit (CU) of the base station when a radio resource control (RRC) connection is established by the UE.

3. The processor of claim 1, wherein the response is a registration accept message comprising an indication that mobile base station relay operation is not allowed.

4. The processor of claim 3, the operations further comprising:
initiating a backoff timer in response to the indication included in the registration accept message; and
transmitting a second registration request to the base station of the network comprising the indication of whether the UE intends to operate as a mobile base station relay.

5. The processor of claim 3, the operations further comprising:
identifying, after the registration accept message is received, a location based condition; and
transmitting a second registration request to the base station of the network comprising the indication of whether the UE intends to operate as a mobile base station relay, wherein transmitting the second registration request is triggered based on identifying the location based condition.

6. The processor of claim 1, the operations further comprising:
storing information associated with one or more public land mobile networks (PLMNs), the information comprising an indication for each of the one or more PLMNs indicating whether mobile base station relay operation is allowed or not allowed.

7. The processor of claim 1, the operations further comprising:
receiving radio parameters for mobile base station relay operation, including frequency of operation and a geographical area where mobile base station relay operation is allowed.

8. The processor of claim 1, the operations further comprising:
receiving radio parameters for mobile base station relay operation, at least one of a tracking area (TA) or registration area (RA) where mobile base station relay operation is allowed.

9. The processor of claim 1, the operations further comprising:
receiving quality of service (QoS) mapping entries for services the UE may support when operating as the mobile base station relay and serving other UEs.

10. The processor of claim 1, the operations comprising:
receiving a policy container comprising information for one or more of an authorization policy for operating as a mobile base station relay, operation policies for a fifth generation (5G) core (5GC) connection, radio parameters for mobile base station relay operation and quality of service (QoS) mapping entries for services the UE may support when operating as the mobile base station relay and serving other UEs.

11. The processor of claim 1, wherein the response to the registration request is a registration reject message comprising one or more reject causes indicating that mobile base station relay operation is not supported or allowed by the network.

12. The processor of claim 1, wherein the response to the registration request is a deregistration request message indicating that mobile base station relay operation is not supported or allowed by the network.

13. The processor of claim 1, wherein the response to the registration request is a registration reject message or a deregistration request, the operations further comprising:
releasing an F1 interface based on the response, wherein the UE remains connected to the network.

14. The processor of claim 1, the operations further comprising:
receiving an information element (IE) from a home public land mobile network (HPLMN), the IE comprising an indication that mobile base station relay operation is allowed in roaming scenarios.

15. The processor of claim 1, the operations further comprising:
a registration accept message comprising an information element (IE) indicating a list of public land mobile networks (PLMNs) that support mobile base station relay operation.

16. An access and mobility management function (AMF) configured to perform operations, comprising:
receiving a message from a radio access network (RAN), the message comprising an indication of whether a user equipment (UE) intends to operate as a mobile base station relay; and
transmitting a response to the message to the RAN.

17. The AMF of claim 16, wherein the message is a N2 initial UE message.

18. The AMF of claim 16, the operations further comprising:
receiving a Nudm_SDM_Get response from a unified data management (UDM) indicating whether the UE is permitted to operate as a mobile base station relay.

19. The AMF of claim 16, the operations further comprising:
triggering a setup of a UE context or a modification of the UE context for the UE comprising an indication that the UE is authorized as a mobile base station relay.

20. The AMF of claim 16, wherein the response to the message is a registration accept message comprising an information element (IE) indicating a list of public land mobile networks (PLMNs) that support mobile base station relay operation.
